(19) United States
(12) Patent Application Publication
(10) Pub. No.: US 2025/0115202 A1
(43) Pub. Date: Apr. 10, 2025

(54) VEHICLE BUMPER ASSEMBLY

(71) Applicant: Ford Global Technologies, LLC, Dearborn, MI (US)

(72) Inventors: Dean M. Jaradi, Macomb, MI (US); Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 18/483,710

(22) Filed: Oct. 10, 2023

(51) Int. Cl. B60R 19/22; B60R 19/18; B60R 19/34

(52) U.S. Cl. CPC B60R 19/22; B60R 19/34; B60R 2019/1866; B60R 2019/1873

(57) ABSTRACT

A vehicle includes a vehicle frame including a first frame rail and a second frame rail each elongated along a vehicle-longitudinal axis. The first frame rail is spaced from the second frame rail along a vehicle-lateral axis. The vehicle includes a bumper supported by the first frame rail and the second frame rail. The bumper includes a crossbeam elongated along the vehicle-lateral axis. The bumper includes a cell structure vehicle-forward of the crossbeam, the cell structure including cell walls that define cell chambers. The bumper includes foam disposed in the cell chambers.

### BACKGROUND

The desired stiffness of a vehicle bumper may be different depending on vehicle speed. For example, at a low vehicle speed, a higher stiffness may be desired to prevent damage to the bumper, while at a high vehicle speed, a lower stiffness may be desired during certain pedestrian and/or vehicle impacts.

Several vehicle research organizations release crash test standards for vehicles directed to specific outcomes. One example test is directed toward low speed damageability (LSD), e.g., damage to vehicle components at relatively low speeds. However, as described above, the stiffness desired for the bumper system for LSD may differ from the stiffness desired for pedestrian protection. For example, other protocols for pedestrian leg impact may be benefited by a lower stiffness of the bumper in comparison to the stiffness desired for LSD. In other words, requirements for LSD and pedestrian protection may create competing design principles. There remains an opportunity to design a vehicle bumper that accounts for low speed damageability and pedestrian impact.

### BRIEF DESCRIPTION OF THE DRAWINGS

FIG. 1 is a perspective view of a front portion of a vehicle with a bumper having an energy absorbing cell structure.

FIG. 2 is a top cross section view the portion of the vehicle with a bumper having an energy absorbing cell structure.

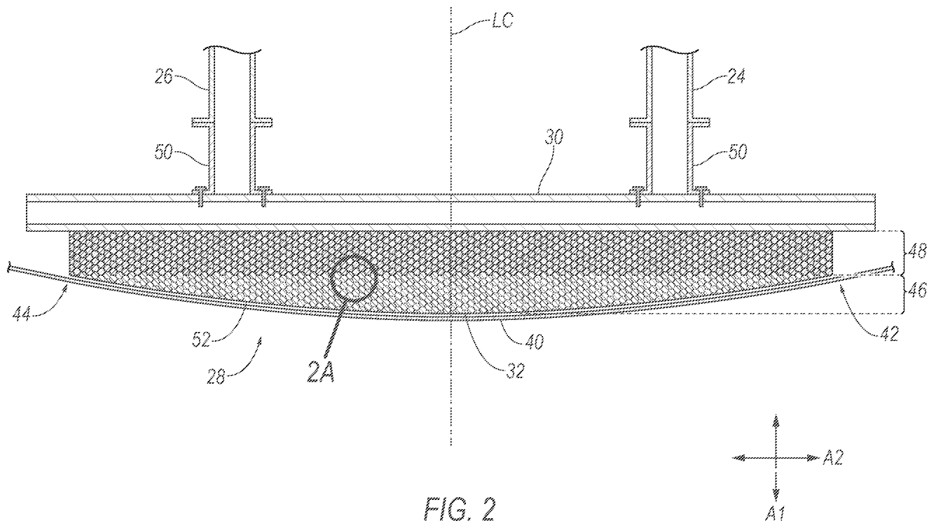

FIG. 2A is an enlarged view of a portion of the top cross section view of the energy absorbing cell structure.

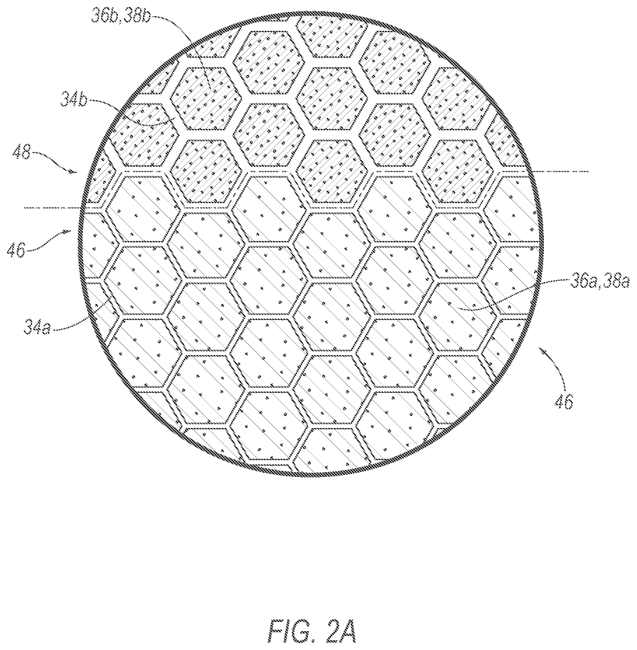

FIG. 3 is a side view of a portion the vehicle during a pendulum impact test.

FIG. 4 is a top cross section view of the portion the vehicle during the pendulum impact test.

### DETAILED DESCRIPTION

A vehicle includes a vehicle frame with a first frame rail and a second frame rail each elongated along a vehicle-longitudinal axis, the first frame rail spaced from the second frame rail along a vehicle-lateral axis. The vehicle includes a bumper supported by the first frame rail and the second frame rail. The bumper includes a crossbeam elongated along the vehicle-lateral axis. The bumper includes a cell structure vehicle-forward of the crossbeam. The cell structure includes cell walls that define cell chambers. The bumper includes foam disposed in the cell chambers.

The cell structure may extend along the vehicle-lateral axis from the first frame rail to the second frame rail.

The cell structure may include a first portion elongated along the vehicle-lateral axis and a second portion elongated along the vehicle-lateral axis, the first portion having a lower crush strength than the second portion.

The foam in the cell chambers of the first portion may be open cell and the foam in the cell chambers of the second portion may be closed cell.

The open cell foam may have a density of 0.4 to 1.4 pounds per cubic foot and the closed cell foam may have a density of 2.5 to 3.2 pounds per cubic foot.

The cell walls of the first portion may be thinner than the cells walls of the second portion.

The cell walls of the first portion may have a thickness of 0.5 millimeter and the cell walls of the second portion may have a thickness of 1 millimeter.

The cell walls of the first portion and the cells walls of the second portion may be monolithic.

A length of the first portion along the vehicle-longitudinal axis may vary along the vehicle-lateral axis.

The first portion may extend further along the vehicle-longitudinal axis at a lateral center of the vehicle than outboard of the lateral center.

The second portion may extend a same length along the vehicle-longitudinal axis at the lateral center of the vehicle and outboard of the vehicle-lateral center.

The vehicle may include an outer panel supported by the vehicle frame, the outer panel extending along the vehicle-lateral axis at the lateral center of the vehicle and extending oblique to the vehicle-lateral axis outboard of the lateral center.

The first portion may be forward of the second portion.

The cell structure may be fixed to the crossbeam.

The cell chambers may be elongated along a vehicle-vertical axis.

The cell chambers may be hexagonal.

Each of the cell walls may have a length of 6 to 7 millimeters.

With reference to the Figures, wherein like numerals indicate like parts throughout the several views, a vehicle 20 with a vehicle frame 22 is shown. The vehicle frame 22 includes a first frame rail 24 and a second frame rail 26. The first frame rail 24 and the second frame rail 26 are each elongated along a vehicle-longitudinal axis A1. The first frame rail 24 is spaced from the second frame rail 26 along a vehicle-lateral axis A2. The vehicle 20 includes a bumper 28 supported by the first frame rail 24 and the second frame rail 26. The bumper 28 includes a crossbeam 30 elongated along the vehicle-lateral axis A2. The bumper 28 includes a cell structure 32 that is vehicle-forward of the crossbeam 30. The cell structure 32 includes cell walls 34a, 34b that define cell chambers 36a, 36b. The bumper 28 includes foam 38a, 38b disposed in the cell chambers 36a, 36b.

The vehicle 20 may be any type of passenger or commercial automobile such as a car, a truck, a sport utility vehicle, a crossover vehicle, a van, a minivan, a taxi, a bus, etc.

In the present application, relative vehicular orientations and directions by way of example, top, bottom, front, rear, outboard, inboard, inward, outward, lateral, left, right, etc., are from the perspective of an occupant seated in the vehicle 20 and facing forward, e.g., toward a forward instrument panel and/or forward windshield of the vehicle 20. The forward direction of the vehicle 20 is the direction of movement of the vehicle 20 when the vehicle 20 is engaged in forward drive with wheels of the vehicle 20 straight. Orientations and directions relative to the assembly are given related to when the assembly is supported by the vehicle 20 as described below and shown in the Figures.

The vehicle 20 defines the vehicle-longitudinal axis A1 that extends between a front and a rear of the vehicle 20. The vehicle 20 defines the vehicle-lateral axis A2 that extends between a left-side and a right-side of the vehicle 20. The vehicle 20 defines a vehicle-vertical axis A3 that extends between a top and a bottom of the vehicle 20. The vehicle-lateral axis A2, the vehicle-longitudinal axis A1, and the vehicle-vertical axis A3 are perpendicular relative to each other.

The vehicle 20 may include a body and the frame 22. The body and frame 22 may be of a unibody construction. In the unibody construction, the body, e.g., rockers, pillars, roof rails, etc., serve as the frame 22, and the body (including the rockers, pillars, roof rails, etc.) is unitary, i.e., a continuous one-piece unit. As another example, the body and frame 22 may have a body-on-frame construction (also referred to as a cab-on-frame construction). In other words, the body and frame 22 are separate components, i.e., are modular, and the body is supported on and affixed to the frame 22. Alternatively, the body and frame 22 may have any suitable construction. The body and/or the frame 22 may be any suitable material, for example, steel, aluminum, etc.

The vehicle body includes body panels (not numbered). The body panels may include structural panels, e.g., rockers, pillars, roof rails, etc. The body panels may include exterior panels. The exterior panels may present a class-A surface, i.e., a finished surface exposed to view by a customer and specifically manufactured to have a high-quality, finished aesthetic appearance free of unaesthetic blemishes and defects. The body panels include, e.g., a roof panel, door panels, fenders, hood 54, a decklid, etc. The vehicle body may define a passenger cabin to house occupants of the vehicle 20.

The vehicle frame 22 includes the first frame rail 24 and the second frame rail 26 and may include cross beams. The first frame rail 24 and the second frame rail 26 are elongated along the vehicle-longitudinal axis A1. The first frame rail 24 and the second frame rail 26 are spaced from each other cross-vehicle, i.e., along the vehicle-lateral axis A2. The cross beams of the vehicle frame 22 extend from the first frame rail 24 to the second frame rail 26 transverse to the vehicle-longitudinal axis A1.

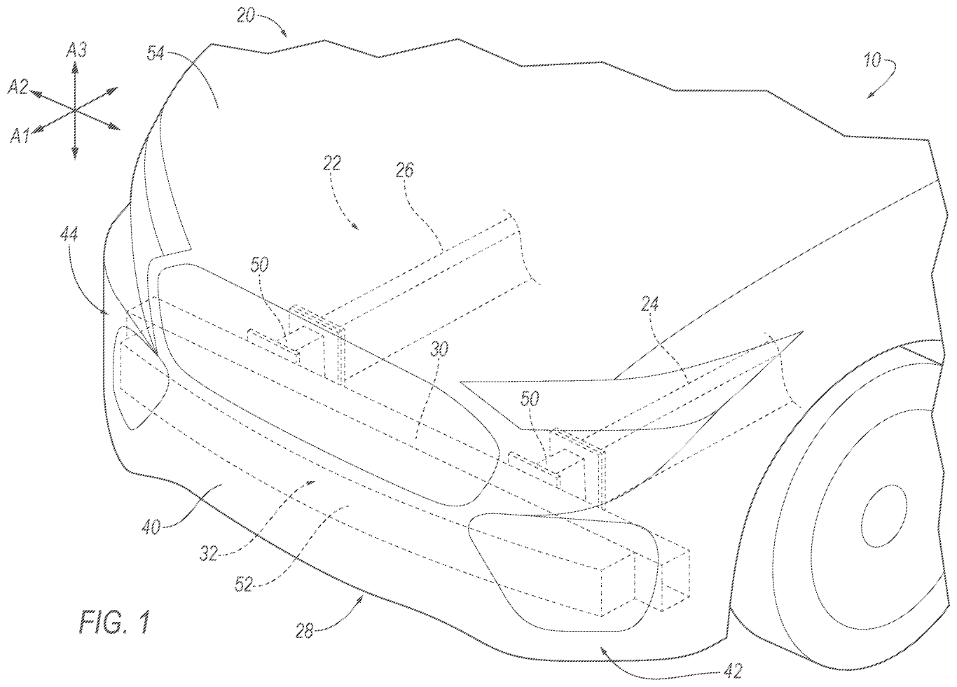

With continued reference to FIG. 1, the first frame rail 24 and the second frame rail 26 may define the cross-vehicle boundaries of the vehicle frame 22. The first frame rail 24 and the second frame rail 26 may be elongated along the vehicle-longitudinal axis A1 from a rear end of the vehicle 20 to a front end of the vehicle 20. In some examples, the first frame rail 24 and the second frame rail 26 may extend along substantially the entire length of the vehicle 20. In other examples, the first frame rail 24 and the second frame rail 26 may be segmented and extend under portions of the vehicle 20, e.g., at least extending from below a passenger compartment of the vehicle 20 to the front end of the vehicle 20. In some examples, the first frame rail 24 and the second frame rail 26 each may be unitary from the rear end of the vehicle 20 to the front end of the vehicle 20. In other examples, the first frame rail 24 and the second frame rail 26, respectively, may each include segments fixed to each other (e.g., by welding, threaded fastener, etc.) and in combination extending from the rear end of the vehicle 20 to the front end of the vehicle 20. The first frame rail 24 and the second frame rail may include crush cans 50 at the front end of the vehicle 20, as shown in the example in the Figures. The crush cans 50 directly support the bumper 28. In other words, the bumper 28 may abut the crush cans 50 and the weight of the bumper 28 may be borne by the crush cans 50, as shown in the example in the Figures.

As set forth above, the vehicle frame 22 may have a body-on-frame construction in which the vehicle body is supported on and affixed to the vehicle frame 22. In such an example, the first frame rail 24 and the second frame rail 26 may each include cab mount brackets (not shown) on which the vehicle body is supported and affixed. The cab mount brackets are fixed to the first frame rail 24 and the second frame rail 26, e.g., welded to the first frame rail 24 and the second frame rail 26. The cab mount brackets may extend outboard from the respective first frame rail 24 and the second frame rail 26. The cab mount bracket may be cantilevered from the respective first frame rail 24 and the second frame rail 26. The cab mount brackets are configured to support the vehicle body in a body-on-frame configuration. For example, the cab mount brackets may include a post or a hole that receives a hole or a post, respectively, of the vehicle body to connect the vehicle body to the vehicle frame 22. Specifically, the vehicle body may be fixed to the cab mount brackets. During assembly of the vehicle 20, the vehicle body is set on the vehicle frame 22 with fastening features of the vehicle body aligned with the cab mount brackets for engagement with the cab mount brackets.

The vehicle frame 22 may include suspension and steering attachment points (not shown) that support suspension and steering components of the vehicle 20. As one example, the suspension and steering attachment points may be suspension towers. Suspension and steering components of the vehicle 20 are connected to the vehicle frame 22, at least in part, at the suspension towers. The suspension and steering components include suspension shocks, suspension struts, steering arms, steering knuckles, vehicle wheels, etc.

With reference to FIG. 1, the vehicle has a front-end structure. The front-end structure includes the bumper 28 and may include a grill. The grill is above the bumper 28. The grill may be a component of the vehicle body and may be supported on other components of the vehicle body.

The vehicle 20 includes the bumper 28 to distribute force and absorb energy, e.g., during certain impacts to the vehicle 20. Certain impacts to the vehicle 20 are impacts that are at or above a specified threshold amount of force and may also be dependent on location of the impact and/or angle of the impact. The bumper 28 may include the crossbeam 30, the cell structure 32, the foam 38a, 38b, an outer panel 40, and/or any other suitable structure. The bumper 28 extends from a first end 42 to a second end 44. The first end 42 and the second end 44 may be spaced from each other along the vehicle-lateral axis A2. The bumper 28 may be elongated along the vehicle-lateral axis A2, e.g., from the first end 42 to the second end 44. For example, the first end 42 may be at the left-side of the vehicle 20, and the second end 44 may be at the right-side of the vehicle 20. The bumper 28 may be at the front of the vehicle 20. The bumper 28 may be supported by, e.g., fixed to, the frame 22. The bumper 28 may include components of the frame 22 and/or body.

The bumper 28 includes the crossbeam 30. The crossbeam 30 is elongated along the vehicle-lateral axis A2, e.g., from the first end 42 to the second end 44 of the bumper 28. The crossbeam 30 may be supported by the frame 22, i.e., the weight of the crossbeam 30 may be borne by the frame 22 (for example, by the first frame rail 24 and the second frame rail 26, as shown in the example in the Figures). The crossbeam 30 may be directly supported by the frame 22, and specifically the first frame rail 24 and the second frame rail 26, i.e., with no intermediate components between the crossbeam 30 and the first and second frame rails 24, 26. The crossbeam 30 may be fixed to the first frame rail 24 and the second frame rail 26, e.g., via fastener, weld, etc. The crossbeam 30 may be directly fixed to the first frame rail 24 and the second frame rail 26, i.e., with no intermediate components between the crossbeam 30 and the first frame rail 24 and the second frame rail 26. For example, as shown in the example in the Figures, the crossbeam 30 may be supported directly by and fixed directly to the crush cans 50 of the first frame rail 24 and the second frame rail 26. The crossbeam 30 may be any suitable material, for example, steel, aluminum, etc.

The bumper 28 may include the outer panel 40 to provide an aesthetic appearance to the bumper 28. The outer panel 40 may be elongated generally parallel to the crossbeam 30. The outer panel 40 may extend around the crossbeam 30. The outer panel 40 may present a class-A surface. The outer panel 40 may extend along the vehicle-lateral axis A2 at a lateral center LC of the vehicle 20. For example, a portion of the class-A surface of the outer panel 40 that is midway between the first end 42 and the second end 44 of the bumper 28 may extend parallel to the vehicle-lateral axis A2. In other words, a normal vector extending from the class-A surface of the outer panel 40 at the lateral center LC of the outer panel 40 may be parallel to the vehicle-longitudinal axis A1. The outer panel 40 may extend oblique, i.e., not parallel or perpendicular, to the vehicle-lateral axis A2 outboard of the lateral center LC. For example, the class-A surface of the outer panel 40 at the first end 42 and the second end 44 of the crossbeam 30 may extend oblique to the vehicle-lateral axis A2. In other words, a normal vector extending from the class-A surface of the outer panel 40 outboard of the lateral center LC may be oblique to the vehicle-longitudinal axis A1. The outer panel 40 may be supported by the frame 22. The outer panel 40 may be a component of the body.

The cell structure 32 absorbs energy during certain impacts to the vehicle 20. For example, the cell structure 32 may be deformed during certain impacts to the vehicle 20. The cell structure 32 is forward of the crossbeam 30. For example, the cell structure 32 may be between the crossbeam 30 and the outer panel 40 along the vehicle-longitudinal axis A1. The cell structure 32 is supported by the crossbeam 30. For example, the cell structure 32 may be fixed to the crossbeam 30 via fastener, adhesive, or other suitable structure. The cell structure 32 extends along the vehicle-lateral axis A2, e.g., from the first frame rail 24 to the second frame rail 26. For example, the cell structure 32 may extend from the first end 42 of the bumper 28 to the second end 44 of the bumper 28. The cell structure 32 may be elongated along the vehicle-lateral axis A2. In other words, the cell structure 32 may extend along the vehicle-lateral axis A2 longer than along the vehicle-longitudinal axis A1 or the vehicle-vertical axis A3. The cell structure 32 may include a cover 52. The cover 52 may surround and enclose the cell walls 32a, 34b, e.g., along a top, bottom, front, rear, and/or sides of the cell structure 32. The cover 52 may be plastic or any suitable material.

The cell structure 32 includes the cell walls 34a, 34b that define the cell chambers 36a, 36b of the cell structure 32. The cell walls 34a, 34b of the cell structure 32 surround the cell chambers 36a, 36b. The cell chambers 36a, 36b may be elongated along the vehicle-vertical axis A3. In other words, the cell chambers 36a, 36b may be longer along the vehicle-vertical axis A3 than along the vehicle-lateral axis A2 and the vehicle-longitudinal axis A1. The cell chambers 36a, 36b may be hexagonal. In other words, each cell chamber 36a, 36b may be surrounded by six cell walls 34a, 34b. The cell walls 34a, 34b may be elongated along the vehicle-vertical axis A3. In other words, the cell walls 34a, 34b may be longer along the vehicle-vertical axis A3 than from one adjacent cell wall 34a, 34b to an opposite adjacent cell wall 34a, 34b. Each of the cell walls 34a, 34b may have a length of 6 to 7 millimeters. In other words, a length of each of the cell walls 34a, 34b from one adjacent cell wall 34a, 34b to the opposite adjacent cell wall 34a, 34b may be 6 to 7 millimeters. The cell walls 34a, 34b may be aluminum, plastic, or any suitable material.

The cell structure 32 includes a first portion 46 and a second portion 48. The first portion 46 and the second portion 48 are both elongated along the vehicle-lateral axis A2. The first portion 46 and the second portion 48 of the cell structure 32 may extend from the first end 42 to the second end 44 of the bumper 28. The first portion 46 is forward of the second portion 48. For example, the first portion 46 may be between the outer panel 40 and the second portion 48 along the vehicle-longitudinal axis A1. The second portion 48 may be between the first portion 46 and the crossbeam 30 along the vehicle-longitudinal axis A1. The cell walls 34a of the first portion 46 and the cell walls 34b of the second portion 48 of the cell structure 32 may be monolithic. Monolithic means a single, uniform piece of material with no seams, joints, fasteners, or adhesives holding it together, i.e., formed together simultaneously as a single continuous unit, e.g., by machining from a unitary blank, molding, extruding, 3-D printing, etc. Non-monolithic components, in contrast, are formed separately and subsequently assembled, e.g., by threaded engagement, welding, etc.

A length of the first portion 46 along the vehicle-longitudinal axis A1 may vary along the vehicle-lateral axis A2. In other words, the length of the first portion 46 along the vehicle-longitudinal axis A1 may be different at one position along the vehicle-lateral axis A2 that at another position along the vehicle-lateral axis A2. For example, the first portion 46 may extend further along the vehicle-longitudinal axis A1 at the lateral center LC of the vehicle 20 than outboard of the lateral center LC. In other words, the length of the first portion 46 along the vehicle-longitudinal axis A1 may be longer at the lateral center LC than spaced from the lateral center LC along the vehicle-lateral axis A2. For example, the length of the first portion 46 along the vehicle-longitudinal axis A1 may taper at the first end 42 and at the second end 44 of the bumper 28. The shorter length of the first portion 46 outboard of the lateral center LC provides different energy absorption characteristics, e.g., at the first end 42 and the second end 44 than at the lateral center LC. For example, the shorter length of the first portion 46 outboard of the lateral center LC may absorb less energy than the longer length of the first portion 46 at of the lateral center LC, e.g., based on different vectors of force that may be applied to the first portion 46 at the lateral center LC that outboard of the vehicle 20 center during curtain impacts to the vehicle 20. For example, normal force from certain impacts to the outer panel 40 at the lateral center LC may be transferred to the first portion 46 only along the vehicle-longitudinal axis A1. Normal force from certain impacts to the outer panel 40 outboard of the lateral center LC may be in part transferred to the first portion 46 along the vehicle-longitudinal axis A1 and may be in part deflected along the vehicle-lateral axis A2.

The second portion 48 may extend a same length along the vehicle-longitudinal axis A1 at the lateral center LC of the vehicle 20 and outboard of the lateral center LC. For example, the length of the second portion 48 along the vehicle-longitudinal axis A1 may be generally consistent from the first end 42 to the second end 44 of the bumper 28.

The first portion 46 may have a lower crush strength than the second portion 48. In other words, an amount of force necessary to deform the first portion 46 a certain amount is less than an amount of force necessary to deform the second portion 48 the certain amount, e.g., along the vehicle-longitudinal axis A1. For example, the first portion 46 may have a crush strength selected based on a FLEX-PLI leg impactor pedestrian leg protection test, or other conventional test to measure interaction between the vehicle 20 and the leg impactor. The second portion 48 may have a crush strength selected based on a pendulum impact test (further discussed below), a RCAR bumper impact test, or other conventional test to measure intrusion into the front end of the vehicle 20.

The cell walls 34a of the first portion 46 may be thinner than the cell walls 34b of the second portion 48. The thickness of each cell wall 34a, 34b is perpendicular to the vehicle-vertical axis A3 and to the length from one adjacent cell wall 34a, 34b to the opposite adjacent cell wall 34a, 34b. The thinner cell walls 34a of the first portion 46 have a lower crush strength than the thicker cell walls 34b of the second portion 48, e.g., when the first portion 46 and the same portion are a same material. For example, the cell walls 34a of the first portion 46 may have a thickness of 0.5 millimeter and the cell walls 34b of the second portion 48 have a thickness of 1 millimeter.

The foam 38a, 38b is disposed in the cell chambers 36a, 36b to absorb energy during certain impacts to the vehicle 20. The foam 38a, 38b may be deformed during certain impacts to the vehicle 20. The foam 38a, 38b may be polyurethane, natural sponge foam, reticulated foam, Icynene, open cell rubber, or any suitable material.

The foam 38a in the cell chambers 36a of the first portion 46 may have a lower crush strength than the foam 38b in the cell chambers 36b of the second portion 48. For example, the foam 38a in the cell chambers 36a of the first portion 46 may be open cell and the foam 38b in the cell chambers 36b of the second portion 48 be closed cell. The open cell foam 38a may have a higher density than the closed cell foam 38b. For example, the open cell foam 38a may have a density of 0.4 to 1.4 pounds per cubic foot and the closed cell foam 38b may have a density of 2.5 to 3.2 pounds per cubic foot.

During certain impacts to the bumper 28 that are of relatively lower force the first portion 46, and not second portion 48, may deform. Deformation of the first portion 46 limits force applied to the object impacting the bumper 28, e.g., to be relatively lower than that required for the second portion 48. During certain impacts to the bumper 28 that are of relatively higher force the first portion 46 and second portion 48 may deform. Deformation of the second portion 48 may provide relatively higher reaction force and limit intrusion of the object into the bumper 28, e.g., preventing deformation of the hood 54 of the vehicle 20.

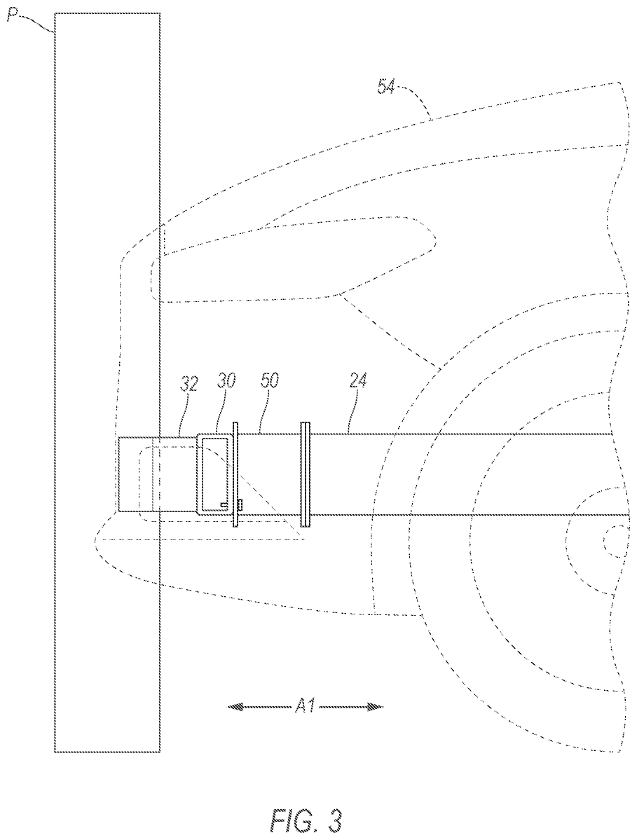

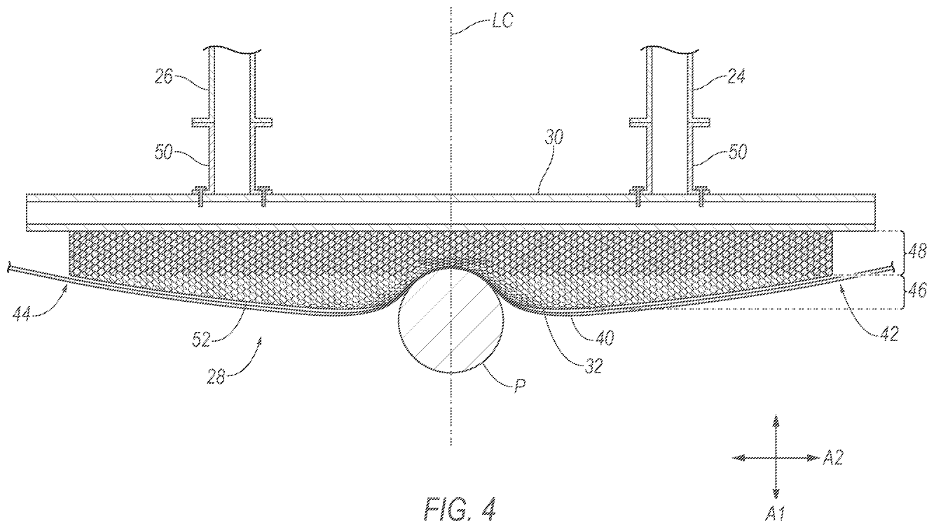

With reference to FIGS. 3 and 4, an example pendulum impact test, such as one described in Code of Federal Regulations 49 Part 581 Bumper Standard, is illustrated. The pendulum impact test uses a pendulum P to impact the bumper 28 at specified heights and angles. With the pendulum test an amount of deformation of the cell structure 32 and the hood 54 of the vehicle 20 can be measured. Based on the results of such test the materials and other design criteria (such as dimensions) of the cell walls 34a, 34b, the foam 38a, 38b, the first portion 46, and the second portion 48 change be selected, e.g., to reduce deformation of the hood 54 and/or meet other damageability requirements while still providing suitable characteristics for pedestrian leg protection tests, as described above.

The numerical terms adjectives “first” and “second,” including with respect to the first frame rail 24, the second frame rail 26, the first portion 46 and the second portion 48, are used herein merely as identifiers and do not signify order or importance.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle, comprising:
a vehicle frame including a first frame rail and a second frame rail each elongated along a vehicle-longitudinal axis, the first frame rail spaced from the second frame rail along a vehicle-lateral axis; and
a bumper supported by the first frame rail and the second frame rail;
the bumper including a crossbeam elongated along the vehicle-lateral axis;
the bumper including a cell structure vehicle-forward of the crossbeam, the cell structure including cell walls that define cell chambers; and
the bumper including foam disposed in the cell chambers.

2. The vehicle of claim 1, wherein the cell structure extends along the vehicle-lateral axis from the first frame rail to the second frame rail.

3. The vehicle of claim 1, wherein the cell structure includes a first portion elongated along the vehicle-lateral axis and a second portion elongated along the vehicle-lateral axis, the first portion having a lower crush strength than the second portion.

4. The vehicle of claim 3, wherein the foam in the cell chambers of the first portion is open cell and the foam in the cell chambers of the second portion is closed cell.

5. The vehicle of claim 4, wherein the open cell foam has a density of 0.4 to 1.4 pounds per cubic foot and the closed cell foam has a density of 2.5 to 3.2 pounds per cubic foot.

6. The vehicle of claim 3, wherein the cell walls of the first portion are thinner than the cells walls of the second portion.

7. The vehicle of claim 6, wherein the cell walls of the first portion have a thickness of 0.5 millimeter and the cell walls of the second portion have a thickness of 1 millimeter.

8. The vehicle of claim 6, wherein the cell walls of the first portion and the cells walls of the second portion are monolithic.

9. The vehicle of claim 3, wherein a length of the first portion along the vehicle-longitudinal axis varies along the vehicle-lateral axis.

10. The vehicle of claim 9, wherein the first portion extends further along the vehicle-longitudinal axis at a lateral center of the vehicle than outboard of the lateral center.

11. The vehicle of claim 10, wherein the second portion extends a same length along the vehicle-longitudinal axis at the lateral center of the vehicle and outboard of the vehicle-lateral center.

12. The vehicle of claim 10, further comprising an outer panel supported by the vehicle frame, the outer panel extending along the vehicle-lateral axis at the lateral center of the vehicle and extending oblique to the vehicle-lateral axis outboard of the lateral center.

13. The vehicle of claim 3, wherein the first portion is forward of the second portion.

14. The vehicle of claim 1, wherein the cell structure is fixed to the crossbeam.

15. The vehicle of claim 1, wherein the cell chambers are elongated along a vehicle-vertical axis.

16. The vehicle of claim 1, wherein the cell chambers are hexagonal.

17. The vehicle of claim 16, wherein each of the cell walls has a length of 6 to 7 millimeters.
